(19) United States
(12) Patent Application Publication
(10) Pub. No.: US 2026/0099709 A1
(43) Pub. Date: Apr. 9, 2026

(54) METHOD FOR MODEL-BASED RANGING AND LOCALIZATION

(71) Applicant: ZaiNar, Inc., Redwood City, CA (US)

(72) Inventors: Luca Rigazzio, Redwood City, CA (US); Siamak Yousefi, Redwood City, CA (US)

(21) Appl. No.: 19/349,151

(22) Filed: Oct. 3, 2025

Related U.S. Application Data
(60) Provisional application No. 63/702,791, filed on Oct. 3, 2024.

(51) Int. Cl. G06N 3/08; G06N 3/045; H04B 17/20

(52) U.S. Cl. CPC G06N 3/08; G06N 3/045; H04B 17/252

(57) ABSTRACT

A method includes: accessing time-difference-of-arrival data associated with a signal transmitted by a transmitter and received by a pair of nodes in an environment; generating parameters of a mixture model based on the time-difference-of-arrival data and a neural network; generating a probability density function, in a set of probability density functions, representing a distribution of distances between the transmitter and the pair of nodes based on the parameters and the time-difference-of-arrival data; based on the set of probability density functions, generating a spatial probability density function representing likelihoods of positions of the transmitter within the environment; calculating a set of likelihoods of the transmitter positioned at a set grid of points representing the environment based on the spatial probability density function; and identifying a target grid point exhibiting highest likelihood in the set of likelihoods as an estimated position of the transmitter.

### CROSS-REFERENCE TO RELATED APPLICATIONS

This application claims the benefit of U.S. Provisional Application No. 63/702,791, filed on 3 Oct. 2024, which is incorporated in its entirety by this reference.

### TECHNICAL FIELD

This invention relates generally to the field of network-based positioning and more specifically to a new and useful method for model-based ranging and localization within the field of network-based positioning.

### BRIEF DESCRIPTION OF THE FIGURES

FIGS. 1A and 1B are flowchart representations of a method; and

FIG. 2 is a flowchart representation of one variation of the method.

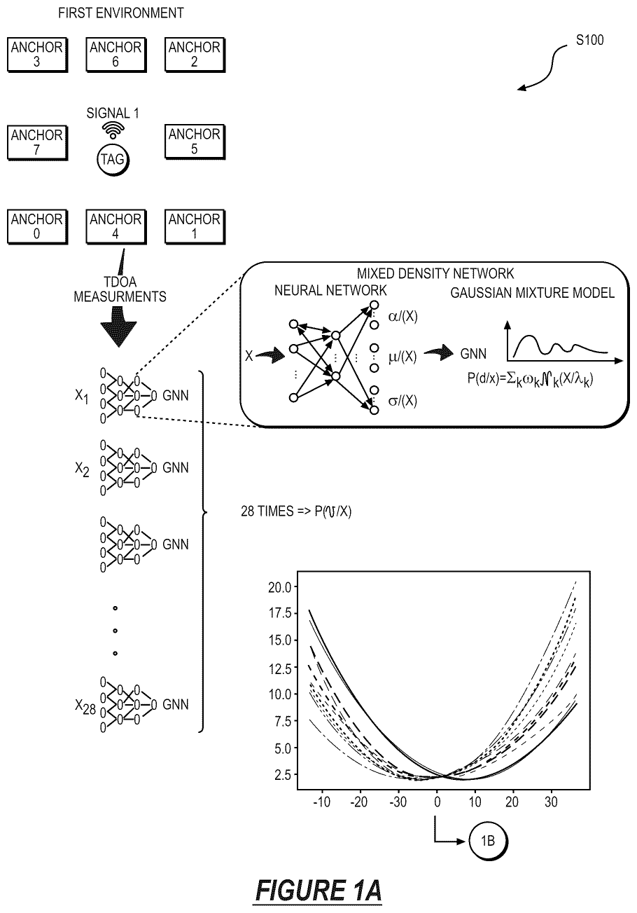

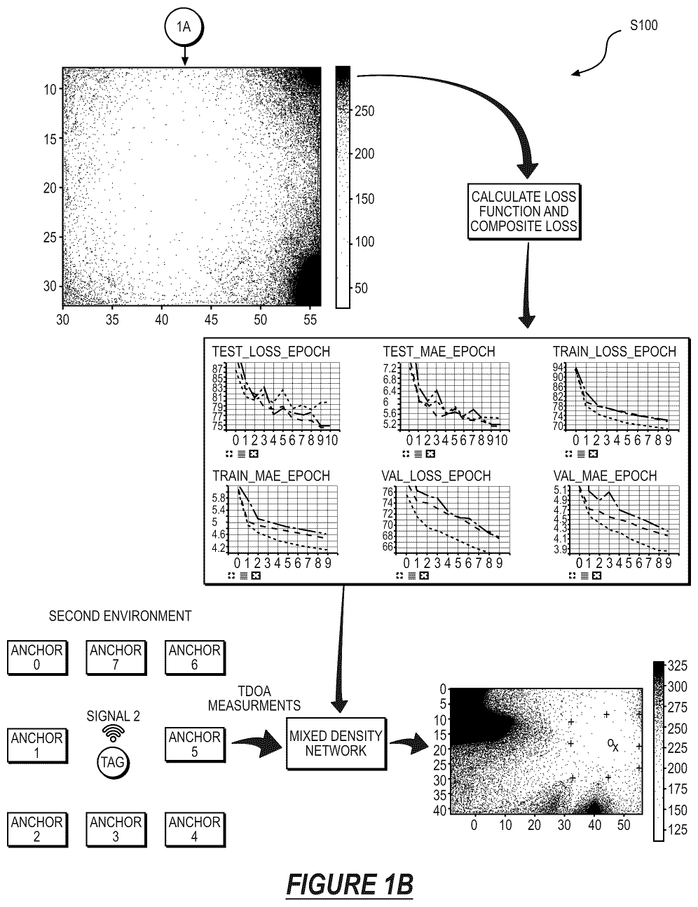

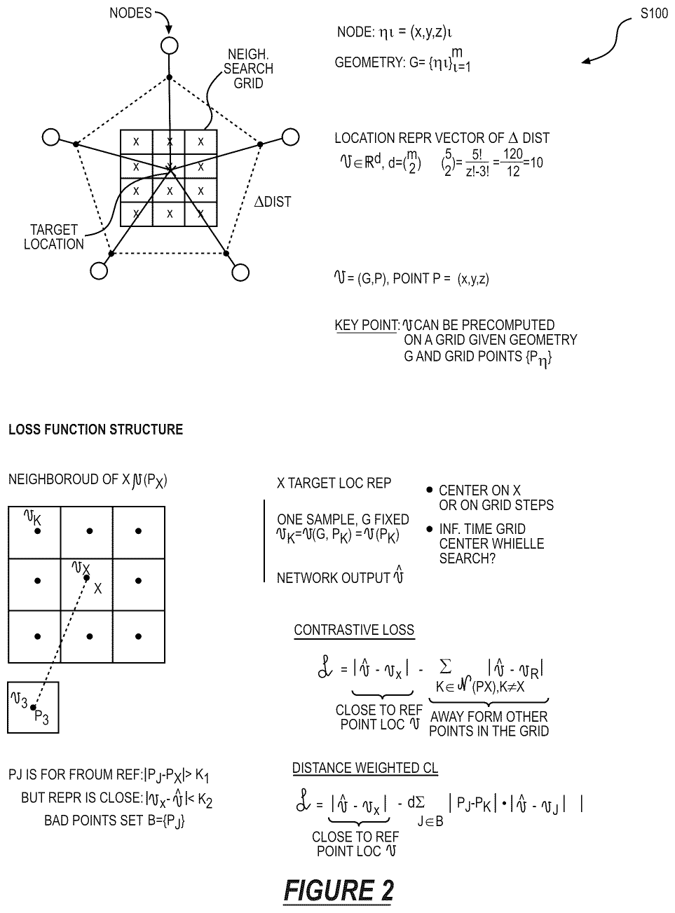

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

As shown in the FIGURES, a method S100 includes, during a first time period: accessing a first set of time-difference-of-arrival measurement data associated with a first signal transmitted by a first transmitter at a first time and received by a first pair of nodes in a first set of nodes arranged in a first geometry within a first environment; generating a first set of parameters of a first mixture model based on the first set of time-difference-of-arrival measurement data and a neural network; generating a first probability density function, in a first set of probability density functions, representing a first distribution of distances between the first transmitter and the first pair of nodes at the first time based on the first set of parameters and the first set of time-difference-of-arrival measurement data; accessing a first set of reference data representing a first known time-difference-of-arrival of the first signal for the first pair of nodes; calculating a first loss function, in a first set of loss functions, for the first probability density function based on the first set of reference data; calculating a first composite loss function based on an average of the first set of loss functions; and training the neural network based on backpropagation of the first set of loss functions and the first composite loss function.

The method S100 also includes, during a second time period succeeding the first time period: accessing a second set of time-difference-of-arrival measurement data associated with a second signal transmitted by a second transmitter at a second time and received by a second pair of nodes in a second set of nodes arranged in a second geometry within a second environment; generating a second set of parameters of a second mixture model based on the second set of time-difference-of-arrival measurement data and the neural network; generating a second probability density function, in a second set of probability density functions, representing a second distribution of distances between the second transmitter and the second pair of nodes at the second time based on the second set of parameters and the second set of time-difference-of-arrival measurement data; generating a spatial probability density function based on the second set of probability density functions, the spatial probability density function representing likelihoods of positions of the second transmitter within the second environment at the second time; calculating a set of likelihoods of the second transmitter positioned at a set of grid points representing the second environment based on the spatial probability density function; and identifying a target grid point, in the set of grid points, exhibiting the highest likelihood in the set of likelihoods as an estimated position of the second transmitter at the second time.

### 2. Applications

Generally, a computer system—including or interfacing with a first set of nodes (e.g., network anchors, wireless access points) arranged in a first geometry within a first environment (e.g., an office space, a warehouse) and a transmitter (e.g., an active tag) —can execute Blocks of the method S100: to access time-difference-of-arrival measurements of a signal transmitted by the transmitter at a first time and received by pairs of nodes; to model these time-difference-of-arrival measurements as probability density functions representing distance (or range) distributions between the transmitter and these pairs of nodes based on a mixed density network that characterizes potential time-difference-of-arrival peaks (or cross-correlation function peaks) according to the time-difference-of-arrival measurements; to combine the probability density functions as a spatial probability density function over the first environment representing relative likelihoods of the transmitter being positioned at various grid points in the first environment; and to estimate a target position of the transmitter at the first time by identifying a target grid point exhibiting the highest likelihood.

Therefore, the computer system can execute Blocks of the method S100: to model multipath components (and possible non-line-of-sight components) together with line-of-sight components of the signal transmitted by the transmitter and received by a pair of nodes; and to characterize a loss function(s) based on multiple range values—rather than a single range value—according to these components in order to increase a likelihood of identifying a peak corresponding to a line-of-sight distance between the transmitter and the node(s), thereby improving accuracy of position estimation.

### 2.1 Mixed Density Network Training and Inference

The computer system can further execute Blocks of the method S100: to access reference data representing a known position of the transmitter within the first environment at the first time; to characterize loss functions for the probability density functions based on a difference between the target position of the transmitter and the known position of the transmitter; to calculate a composite loss function based on (e.g., an average of) the loss functions; and to train the mixed density network by backpropagating the composite loss function through the mixed density network in order to minimize the composite loss function.

Accordingly, the computer system can execute Blocks of the method: to calculate an estimated position of the transmitted based on the mixed density network and time-difference-of-arrival measurements associated with the first set of nodes arranged in the first geometry within the first environment; to characterize error between the estimated position of the transmitter and a known position of the transmitter; and to backpropagate the error through the mixed density network in order to train the mixed density network according to the first set of nodes and/or the first environment.

Additionally, the computer system then can execute Blocks of the method: to access the mixed density network—trained according to the first set of nodes and/or the first environment—and subsequent time-difference-of-arrival measurements of a second signal transmitted by a second transmitter at a second time and received by a second set of nodes in a second environment different from the first environment; to model these subsequent time-difference-of-arrival measurements as probability density functions representing distance (or range) distributions between the transmitter and pairs of nodes in the second set of nodes based on the mixed density network and the subsequent time-difference-of-arrival measurements; to combine these probability density functions as a second spatial probability density function over the second environment representing relative likelihoods of the second transmitter being positioned at various grid points in the second environment; and to estimate a second target position of the second transmitter at the second time by identifying a target grid point exhibiting the highest likelihood.

Therefore, the computer system can execute Blocks of the method S100 to estimate the second target position of the second transmitter based on a zero-shot inference according to the mixed density network absent re-training of the mixed density network based on the second set of nodes and/or the second environment.

### 3. System

Generally, the computer system can include or interface with: a transmitter (e.g., a passive tag, an active tag, a 5G user equipment); and a set of nodes (e.g., wireless tag readers, wireless access points, wireless anchors, 5G gNodeBs).

In one implementation, the system includes: a set of nodes arranged in a first geometry within a first environment (e.g., an office space, a warehouse); and a transmitter arranged at a first position within the first environment at a first time.

In this implementation: the transmitter transmits (e.g., broadcasts) a first signal at the first time; and the set of nodes receives the first signal. For each pair of nodes in the set of nodes, the computer system generates (or accesses) a set of time-difference-of-arrival measurement data based on the first signal received by the pair of nodes.

In another implementation, the computer system includes a mixed density network that generates a probability density function—representing a distribution of distances between the transmitter and a pair of nodes at the first time—based on a set of time-difference-of-arrival measurement data for the pair of nodes.

More specifically, the mixed density network can include a neural network that generates parameters of a mixture model (e.g., a Gaussian mixture model) based on the set of time-difference-of-arrival measurement data. For each component (e.g., a Gaussian component) in a set of components of the mixture model, the neural network can generate a set of parameters (e.g., probability, mean, variance) representing the component based on the set of time-difference-of-arrival measurement data, each component representing a (potential) time-difference-of-arrival peak (or cross-correlation function peak) according to the set of time-difference-of-arrival measurement data. Based on the mixture model, the computer system can generate the probability density function including the set of components.

In this implementation, for each pair of nodes in the set of nodes, the computer system: accesses a set of time-difference-of-arrival measurement data for the pair of nodes; and generates a probability density function—in a set of probability density functions—based on the time-difference-of-arrival measurement data.

Therefore, by generating a multimodal probability density function representing a distribution of distances between a transmitter and a pair of nodes, the computer system can more accurately represent a time-difference-of-arrival based on a line-of-sight component of the signal from the transmitter in order to estimate a range—between the transmitter and the pair of nodes—that is resilient to error due to multipath propagation of the signal, noise, and/or hardware imperfection of these nodes.

In another implementation, the computer system: generates a spatial probability density function—representing likelihoods of positions of the transmitter—based on the set of probability density functions; and calculates a target position of the transmitter at the first time based on the spatial probability density function.

For example, the computer system can: calculate a set of likelihoods of the transmitter positioned at a set grid of points representing the first environment based on the spatial probability density function; and identify a target grid point, in the set of grid points, exhibiting the highest likelihood in the set of likelihoods as the target position of the transmitter at the first time.

Therefore, by calculating the target position of the transmitter based on the spatial probability density function (e.g., corresponding to the target grid point exhibiting the highest likelihood according to the spatial probability density function), the system can reduce error during position estimation due to absence of reception of a line-of-sight component of the signal at a node(s) and/or malfunction of the node(s).

In another implementation, the computer system: accesses a set of reference data representing a known position of the transmitter within the first environment at the first time; for each probability density function in the set of probability density functions, calculates a loss function for the probability density function based on the set of reference data; calculates a composite loss function based on the set of loss functions (e.g., an average of the set of loss functions); and trains the neural network based on backpropagation of the set of loss functions and the composite loss function.

Therefore, by training the neural network based on the composite loss function, the computer system can reduce impact of erroneous sets of time-difference-of-arrival measurements—that exhibit significant amounts of error due to noise and/or that represent absence of reception of a line-of-sight component of the signal—during training of the neural network.

### 5. Range Estimation Based on Mixture Density Network

Generally, for each pair of nodes in a set of nodes arranged within an environment, the computer system can: access a set of time-difference-of-arrival measurement data associated with a signal (e.g., a localization signal) transmitted by a transmitter received by the pair of nodes; generate a set of parameters of a mixture model (e.g., a Gaussian mixture model) based on the set of time-difference-of-arrival measurement data and a neural network; and generate a probability density function, in a set of probability density functions, representing a distribution of distances between the transmitter and the pair of nodes based on the set of parameters and the set of time-difference-of-arrival measurement data.

In one implementation, the computer system generates the probability density function p(t|x) based on (e.g., as a linear combination of) a set of components (e.g., Gaussian components) of a mixture model (e.g., a Gaussian mixture model), where:

$$p ( t \vert x ) = {\sum }_{i = 1}^{m} {α}_{i} ( x ) {ϕ}_{i} ( t \vert x )$$

Therefore, based on the set of time-difference-of-arrival measurement data x={x₁, x₂, . . . , x_{d}} and a set of target output data (e.g., an actual time-difference-of-arrival for the pair of nodes) t={t₁, t₂, . . . , t_{c}}, the computer system can model a multimodal conditional target distribution representing a transformation from the set of time-difference-of-arrival measurement data to the set of target output data.

### 5.1 Time-Difference-of-Arrival Measurement Data

In one implementation, for a first pair of nodes in the set of nodes, the computer system accesses a first set of time-difference-of-arrival measurement data associated with a localization signal transmitted by the transmitter at a first time and received by the first pair of nodes.

For example, the computer system can access the first set of time-difference-of-arrival measurement data including a first set channel state information representing a complex channel for the first pair of nodes including a first node and a second node.

Additionally, the computer system can access the first set of time-difference-of-arrival measurement data including other information, such as: values (e.g., received signal strength indicators) representing signal strength of the localization signal received by the pair of nodes; a first known position of the first node within the first environment; and/or a second known position of the second node within the first environment; etc.

Therefore, the computer system can generate sets of mixture model parameters—based on the first set of time-difference-of-arrival measurement data—for a first set of components of a first mixture model, each component representing a (potential) time-difference-of-arrival peak (or cross-correlation function peak) of the localization signal received by the first pair of nodes according to the first set of time-difference-of-arrival measurement data.

### 5.2 Mixture Model Parameters and Probability Density Function

Generally, for each component (e.g., Gaussian component) in a set of components (e.g., two components, three components), the computer system can generate a subset of parameters of a mixture model (e.g., a Gaussian mixture model) based on the set of time-difference-of-arrival measurement data and a neural network.

In one implementation, for each component i in the set of components m, the neural network generates the subset of parameters zᵢ—based on the set of time-difference-of-arrival measurement data x—including: a probability (or a mixing coefficient) for the component αᵢ; a mean for the component μᵢ; and a variance (or a standard deviation) for the component σᵢ, where:

$$p ( t \vert x ) = {\sum }_{i = 1}^{m} {α}_{i} ( x ) {ϕ}_{i} ( t \vert x )$$

$${ϕ}_{i} ( t \vert x ) = \frac{1}{{( 2 π )}^{c / 2} {{σ}_{i} ( x )}^{c}} exp ( - \frac{{‖ t - {μ}_{i} ( x ) ‖}^{2}}{2 {{σ}_{i} ( x )}^{2}} )$$

$${\sum }_{i}^{m} {α}_{i} ( x ) = 1$$

$${α}_{i} ( x ) = \frac{exp ( {z}_{i}^{α} )}{{\sum }_{j}^{m} exp ( {z}_{j}^{α} )}$$

$${σ}_{i} ( x ) = exp ( {z}_{i}^{σ} )$$

$${μ}_{i} ( x ) = {z}_{ik}^{μ}$$

In another implementation, for a first component—representing a first (potential) time-difference-of-arrival peak—in the first set of components, the computer system generates a first subset of parameters in a first set of parameters of a first mixture model based on the first set of time-difference-of-arrival measurement data and the neural network.

In this implementation, the computer system generates the first subset of parameters z₁ including: a first probability (or a first mixing coefficient) for the first component α₁; a first mean for the first component μ₁; and a first variance (or a first standard deviation) for the first component σ₁.

The computer system repeats the foregoing methods and techniques for each component in the first set of components to generate a subset of parameters in the set of parameters of the first mixture model based on the set of time-difference-of-arrival measurement data.

Therefore, the computer system generates the first set of parameters for the first set of components of the first mixture model in order to generate a first probability density function representing a first distribution of distances between the transmitter and the first pair of nodes.

In another implementation, in response to generating the first set of parameters for the first set of components of the first mixture model, the computer system generates a first probability density function representing a first distribution of distances between the first transmitter and the first pair of nodes at the first time based on the first set of parameters and the first set of time-difference-of-arrival measurement data.

Therefore, rather than estimating a range between the transmitter and the first pair of nodes based on a single time-difference-of-arrival peak (and/or a line-of-sight component of a received localization signal) estimated according to a signal-processing technique (e.g., MUSIC) —which may be inaccurate or erroneous due to noise and/or multipath-induced error, the computer system can estimate the range between the transmitter and the first pair of nodes according to a distribution of possible distances between the transmitter and the first pair of nodes, thereby improving accuracy of range estimation by reducing error due to multipath propagation of the localization signal, noise, and/or hardware imperfection of these nodes.

### 5.4 Additional Probability Density Functions

The computer system repeats the foregoing methods and techniques for each pair of nodes in the set of nodes: to access a set of time-difference-of-arrival measurement data associated with the localization signal transmitted by the transmitter at the first time and received by the pair of nodes; to generate a set of parameters for a set of components of a mixture model based on the set of time-difference-of-arrival measurement data and the neural network; and to generate a probability density function representing a distribution of distances between the first transmitter and the pair of nodes at the first time based on the set of parameters and the set of time-difference-of-arrival measurement data.

### 6. Maximum Likelihood Positioning

Generally, in response to generating the set of probability density functions for pairs of nodes in the set of nodes, the computer system can: generate a spatial probability density function—representing likelihoods of positions of the transmitter within the first environment at the first time—based on the set of probability density functions; calculate a set of likelihoods of the transmitter positioned at a set grid of points representing the first environment based on the spatial probability density function; and identify a target grid point, in the set of grid points, exhibiting the highest likelihood in the set of likelihoods as an estimated position of the transmitter at the first time.

In one implementation, the computer system: defines a set of grid values (e.g., longitude grid values, latitude grid values, altitude grid values) of a coordinate system (e.g., two-dimensional coordinate system, three-dimensional coordinate system) representing the first environment; and defines a set of grid points, each grid point corresponding to a combination of grid values. For example, the computer system can define the set of grid values exhibiting an increment of one meter (or one half meter, etc.).

In another implementation, the computer system: accesses the set of probability density functions; and generates a spatial probability density function based on the set of probability density functions. For example, the computer system can generate the spatial probability density function by combining (e.g., multiplying) the set of probability density functions.

In this implementation, for a first grid point in a set of grid points and corresponding to a first combination of grid values, the computer system calculates a first likelihood—in a set of likelihoods—of the transmitter positioned at the first grid point based on the spatial probability density function.

The computer system repeats the foregoing methods and techniques for each grid point in the set of grid points to calculate a likelihood—in the set of likelihoods—of the transmitter positioned at the grid point based on the spatial probability density function.

In another implementation, the computer system identifies a target grid point, in the set of grid points, exhibiting the highest likelihood in the set of likelihoods as an estimated position of the transmitter at the first time. The computer system can return (e.g., transmit) the estimated position of the transmitter (e.g., to the transmitter, to a node in the set of nodes, to a remote computer system).

Therefore, the computer system can estimate the target position of the transmitter corresponding to the target grid point exhibiting the highest likelihood according to the spatial probability density function in order to reduce error during position estimation due to noise represented in the time-difference-of-arrival measurement data, absence of reception of a line-of-sight component of the signal at a node(s) in the set of nodes, and/or malfunction of the node(s).

### 6.1 Maximum Likelihood Positioning Based on Probability Density Functions

In one variation, the computer system executes the foregoing methods and techniques: to define a set of grid values of a coordinate system representing the first environment; define a set of grid points, each grid point corresponding to a combination of grid values; and access a set of probability density functions representing distances between the transmitter and pairs of nodes in the set of nodes.

In this variation, for a first grid point in the set of grid points and for a first probability density function in the set of probability density functions, the computer system calculates a first likelihood—in a first set of likelihoods associated with the first grid point—of the transmitter positioned at the first grid point based on the first probability density function.

The computer system repeats the foregoing methods and techniques for each probability density function in the set of probability density function to calculate a likelihood—in the first set of likelihoods associated with the first grid point—of the transmitter positioned at the first grid point based on the probability density function.

The computer system calculates a first composite likelihood—in a set of composite likelihoods—of the transmitter positioned at the first grid point based on (e.g., a product of) the first set of likelihoods.

The computer system repeats the foregoing methods and techniques for each grid point in the set of grid points: to calculate a set of likelihoods—associated with the grid point—of the transmitter positioned at the grid point based on the set of probability density functions; and to calculate a composite likelihood, in the set of composite likelihoods, of the transmitter positioned at the grid point based on the set of likelihoods.

In this variation, the computer system: identifies a target grid point, in the set of grid points, exhibiting the highest composite likelihood in the set of composite likelihoods as an estimated position of the transmitter at the first time.

### 6.1 Time-Based Maximum Likelihood Positioning

In another variation, the computer system executes the foregoing methods and techniques to generate a spatial probability density function—representing likelihoods of positions of the transmitter within the first environment at a first time—based on a set of probability density functions.

In this variation, the computer system: accesses a second spatial probability density function representing likelihoods of positions of the transmitter within the first environment at a second time preceding the first time; calculates a set of likelihoods of the transmitter positioned at a set grid of points representing the first environment based on the spatial probability density function and the second spatial probability density function; and identifies a target grid point, in the set of grid points, exhibiting the highest likelihood in the set of likelihoods as an estimated position of the transmitter at the first time.

For example, for a first grid point in a set of grid points and corresponding to a first combination of grid values, the computer system calculates a first likelihood—in a set of likelihoods—of the transmitter positioned at the first grid point based on: the spatial probability density function according to a first weight; and the second spatial probability density function according to a second weight (e.g., a second weight falling below the first weight).

In this example, the computer system can repeat the foregoing methods and techniques for each grid point in the set of grid points to calculate a likelihood—in the set of likelihoods—of the transmitter positioned at the grid point based on: the spatial probability density function according to the first weight; and the second spatial probability density function according to the second weight.

Therefore, by calculating the set of likelihoods of the transmitter positioned at a set grid of points representing the first environment based on the spatial probability density function and the second spatial probability density function, computer system can more accurately estimate a current position of the transmitter traversing through the first environment based on successive spatial probability density functions.

### 7. Mixture Density Network Training

Generally, the computer system can: access a set of reference data representing a known position of the transmitter within the first environment at the first time; calculate a set of loss functions for the set of probability density functions based on the set of reference data; calculate a composite loss function based on the set of loss functions; and train the mixed density network based on backpropagation of the set of loss functions and/or the composite loss function through the mixed density network.

Therefore, the computer system can train the mixed density network—according to the localization signal received by the set of nodes arranged in the first geometry within the first environment—based on backpropagation of the composite loss function through the mixed density network in order to minimize the composite loss function, thereby enabling the computer system: to access a second set of time-difference-of-arrival measurement data associated with a second signal transmitted by a second transmitter and received by a second set of nodes arranged in a second geometry within a second environment; and to estimate a second target position of the second transmitter based on a zero-shot inference according to the mixed density network (e.g., absent re-training of the mixed density network based on the second environment) and the second set of time-difference-of-arrival measurement data.

### 7.1 Reference Data

In one implementation, the computer system accesses a set of reference data representing a known position of the transmitter within the first environment at the first time.

Additionally, for each pair of nodes in the set of nodes, the computer system can access the set of reference data representing a known distance (or range) between the transmitter and the pair of nodes at the first time and/or a known time-difference-of-arrival of the localization signal at the pair of nodes.

### 7.2 Loss Functions

Generally, the computer system can calculate a set of loss functions for the set of probability density functions based on the set of reference data.

More specifically, the computer system can: access the set of reference data t={t₁, t₂, . . . , t_{c}}; and calculate a loss function E for a probability density function based on a pattern q, where:

$$E = {\sum }_{q} {E}^{q} = - log \{ {\sum }_{i = 1}^{m} {α}_{i} ( {x}^{q} ) {ϕ}_{i} ( {t}^{q} \vert {x}^{q} ) \}$$

$$log \{ {ϕ}_{i} ( t \vert x ) \} = - log \{ {( 2 π )}^{c / 2} \} - log \{ {{σ}_{i} ( x )}^{c} \} - \frac{{‖ t - {μ}_{i} ( x ) ‖}^{2}}{2 {{σ}_{i} ( x )}^{2}}$$

$$E = - log \{ {\sum }_{i = 1}^{m} exp \{ log {x}^{q} + log {ϕ}_{i} ( {t}^{q} \vert {x}^{q} ) \} \}$$

In one implementation, the computer system calculates a first loss function, in the set of loss functions, for the first probability density function based on the set of reference data.

For example, the computer system can calculate the first loss function for the first probability density function based on a first known time-difference-of-arrival of the localization signal at a first pair of nodes and/or a first known distance (or range) between the transmitter and the first pair of nodes at the first time.

In this implementation, the computer system can repeat the foregoing methods and techniques for each probability density function in the set of probability density functions to calculate a loss function, in the set of loss functions, for the probability density function based on the set of reference data.

Therefore, for each probability density function in the set of probability density functions, the computer system can calculate a loss function that represents an error between the probability density function and the known distance (or range) between the transmitter and a pair of nodes associated with the probability density function.

### 7.3 Composite Loss Function and Backpropagation

In one implementation, the computer system: calculates a composite loss function based on the set of loss functions; and trains the mixed density network based on backpropagation of the composite loss function through the mixed density network.

For example, the computer system can: calculate the composite loss function corresponding to an average of the set of loss functions; and train the mixed density network based on backpropagation of the composite loss function through the mixed density network (e.g., through the set of probability density functions, the sets of parameters for the mixture models, and/or the neural network).

Therefore, by training the mixed density network based on backpropagation of the composite loss function corresponding to an average of the set of loss functions, the computer system can reduce impact of erroneous sets of time-difference-of-arrival measurements—that may exhibit significant amounts of error due to noise and/or that represent absence of reception of a line-of-sight component of the signal—during training of the mixed density network.

Additionally or alternatively, the computer system can: access the set of reference data representing the known position of the transmitter within the first environment at the first time; calculate a spatial error based on a difference between the estimated position of the transmitter at the first time and the known position of the transmitter; and train the mixed density network based on backpropagation of the spatial error.

### 7.4 Iterative Processing

The computer system can repeat the foregoing methods and techniques: to access subsequent sets of time-difference-of-arrival measurement data associated with a subsequent localization signal transmitted by the transmitter at a subsequent time and received by the set of nodes within the environment; to generate a subsequent set of probability density functions, representing distances between the transmitter and pairs of nodes in the set of nodes based on the subsequent sets of time-difference-of-arrival measurement data and the mixed density network; to generate a subsequent spatial probability density function based on the subsequent set of probability density functions; and to calculate a subsequent target location of the transmitter at the subsequent time based on the subsequent spatial probability density function.

Then, the computer system can repeat the foregoing methods and techniques: to access a subsequent set of reference data representing a subsequent known position of the transmitter within the first environment at the subsequent time; to calculate a subsequent set of loss functions for the subsequent set of probability density functions based on the subsequent set of reference data; to calculate a subsequent composite loss function based on the subsequent set of loss functions; and to train the mixed density network based on backpropagation of the subsequent set of loss functions and/or the subsequent composite loss function through the mixed density network.

Therefore, the computer system can iteratively train the mixed density network based on a set of localization signals transmitted by the transmitter from a set of different positions within the first environment and received by the set of nodes arranged in the first geometry within the first environment.

### 8. Inference in Second Environment

In one implementation, in response to training the mixed density network according to the first environment, the computer system executes the foregoing methods and techniques: to access sets of time-difference-of-arrival measurement data associated with a second localization signal transmitted by a second transmitter at a second time and received by a second set of nodes arranged in a second geometry (e.g., a second geometry different from the first geometry) within a second environment (e.g., a second environment different from the first environment); to generate a second set of probability density functions, representing distances between the second transmitter and pairs of nodes in the second set of nodes based on the sets of time-difference-of-arrival measurement data and the mixed density network; to generate a second spatial probability density function based on the second set of probability density functions; and to calculate a second target location of the second transmitter at the second time based on the second spatial probability density function.

Therefore, based on the mixed density network trained according to the first environment (e.g., the first set of nodes arranged in the first geometry within the first environment), the computer system can estimate the second target position of the second transmitter based on a zero-shot inference according to the mixed density network absent re-training of the mixed density network based on the second set of nodes arranged in the second geometry within the second environment.

In another implementation, the computer system executes the foregoing methods and techniques: to access a second set of reference data representing a second known position of the second transmitter within the second environment at the second time; to calculate a second set of loss functions for the second set of probability density functions based on the second set of reference data; to calculate a second composite loss function based on the second set of loss functions; and to fine-tune the mixed density network based on backpropagation of the second set of loss functions and/or the second composite loss function through the mixed density network.

Therefore, the computer system can iteratively fine-tune the mixed density network based on localization signals transmitted by different transmitters within the different environments and received by sets of nodes arranged in different geometries within these environments in order to increase accuracy of the mixed density network for position estimation in different environments and/or nodes arranged in different geometries.

### 9. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during a first time period:
accessing a first set of time-difference-of-arrival measurement data associated with a first signal transmitted by a first transmitter at a first time and received by a first pair of nodes in a first set of nodes arranged in a first geometry within a first environment;
generating a first set of parameters of a first mixture model based on the first set of time-difference-of-arrival measurement data and a neural network;
generating a first probability density function, in a first set of probability density functions, representing a first distribution of distances between the first transmitter and the first pair of nodes at the first time based on the first set of parameters and the first set of time-difference-of-arrival measurement data;
accessing a first set of reference data representing a first known time-difference-of-arrival of the first signal for the first pair of nodes; calculating a first loss function, in a first set of loss functions, for the first probability density function based on the first set of reference data;
calculating a first composite loss function based on an average of the first set of loss functions; and
training the neural network based on backpropagation of the first set of loss functions and the first composite loss function; and
during a second time period succeeding the first time period:
accessing a second set of time-difference-of-arrival measurement data associated with a second signal transmitted by a second transmitter at a second time and received by a second pair of nodes in a second set of nodes arranged in a second geometry within a second environment;
generating a second set of parameters of a second mixture model based on the second set of time-difference-of-arrival measurement data and the neural network;
generating a second probability density function, in a second set of probability density functions, representing a second distribution of distances between the second transmitter and the second pair of nodes at the second time based on the second set of parameters and the second set of time-difference-of-arrival measurement data;
generating a spatial probability density function based on the second set of probability density functions, the spatial probability density function representing likelihoods of positions of the second transmitter within the second environment at the second time;
calculating a set of likelihoods of the second transmitter positioned at a set of grid points representing the second environment based on the spatial probability density function; and
identifying a target grid point, in the set of grid points, exhibiting the highest likelihood in the set of likelihoods as an estimated position of the second transmitter at the second time.
